(19) United States
(12) Patent Application Publication
(10) Pub. No.: US 2009/0136702 A1
(43) Pub. Date: May 28, 2009

(54) LAMINATED ARMOR HAVING A NON-PLANAR INTERFACE DESIGN TO MITIGATE STRESS AND SHOCK WAVES

(76) Inventor: Yabei Gu, Painted Post, NY (US)

Correspondence Address: CORNING INCORPORATED, SP-TI-3-1, CORNING, NY, 14831, US

(21) Appl. No.: 12/269,384

(22) Filed: Nov. 12, 2008

Related U.S. Application Data
(60) Provisional application No. 61/003,160, filed on Nov. 15, 2007.

(51) Int. Cl. B32B 17/06

(52) U.S. Cl. 428/49

(57) ABSTRACT

The invention is directed to an armor laminate, transparent or non-transparent, comprising a plurality of layers, said laminate having at least one non-planar interface between at least two adjacent layers laminate. In transparent armor embodiments the laminate is a transparent laminate in which each transparent layer is individually selected from the group consisting of transparent glass, glass-ceramics, polymer and crystalline materials. In non-transparent armor laminates the individual layers are typically non-transparent layers such as non-transparent glass-ceramics, aluminum, titanium, steel, and metal alloys. The non-planar interface surfaces according to the invention can be of any non-planar shape. Examples of such shapes, without limitation, include concave/convex, zigzag or sinusoidal shapes.

### CROSS-REFERENCE TO RELATED APPLICATIONS

This application claims the benefit of priority under 35 U.S.C. § 119(e) of U.S. Provisional Application Ser. No. 61/003,160 filed on Nov. 15, 2007.

### FIELD

The invention is directed to armor laminates in which the interface between the laminate layers is a non-planar interface. In particular, the invention is directed to transparent armor laminates in which the interface between adjacent layers is a non-planar interface.

### BACKGROUND

Armor is a material or system of materials designed to protect from ballistic threats. Transparent armor, in addition to providing protection from the ballistic threat is also designed to be optically transparent. The primary requirement for a transparent armor system is that it should not only defeat the designated threat, but it should also to provide a multi-hit capability with minimized distortion of surrounding areas. One solution to these requirements is to increase the thickness in order to improve the ballistic performance of the transparent armor material or system. However, this solution, while suitable for stationary applications such as building windows, is impractical in vehicular applications as it will increase the weight and impose space limitations in many vehicles.

In the general field of ballistic armors, existing transparent armor systems are typically comprised of many layers of projectile resistant material separated by polymer interlayers which can be used to bond the projectile resistant materials. In a typical transparent armor laminate the transparent hard face layer is designed to break up or deform projectiles upon impact while the interlayer material(s) is used to mitigate the stresses from thermal expansion mismatches, as well as to stop crack propagation into the polymers. The most commonly used materials for transparent armor are polymeric materials, crystalline materials, glasses, glass-ceramics and transparent ceramics. The principal problem with transparent armors is that they are generally brittle and have limited ability to withstand either impact or blast.

Transparent materials that are used for ballistic protection (transparent armor) include:
(a) Polymeric materials, the most common being polycarbonate. This is an inexpensive material that can easily be fabricated and offers very good protection against small fragments. It is generally used for goggles, visors, face shields and eye “glasses”. Other plastics such as transparent nylons, acrylates and polyurethanes have also been investigated, but their durability (e.g., to ultraviolet radiation) and optical properties limit their applications.
(b) Conventional glasses, such as soda lime and borosilicate glass, which are typically manufactured using the float process. These materials are low-cost, but increased requirements for lower weight, improved optical properties and ballistic performance have generated the need for improved materials.
(c) Crystalline materials such as aluminum oxynitride (AlON), single crystal aluminum oxide (sapphire) and spinel (MgAl₂O₄) are the major materials presently being considered. These crystalline materials are expensive to make.
(d) Glass-ceramic Materials
   (i) One glass-ceramic material is TransArm™, a lithium disilicate glass-ceramic from Alstom UK Ltd. Due to its superior weight efficiency against ball rounds and small fragments, TransArm has the potential to increase performance of protective devices such as face shields used for explosive ordnance disposal. Studies of the shock behavior of these materials have shown that the glass-ceramic has a high post-failure strength compared to that of amorphous glasses.
   (ii) U.S. Pat. No. 5,060,553 (Jones, 1991) describes armor material based on glass-ceramic bonded to an energy-absorbing, fiber-containing backing layer. Glass compositions listed in the patent that could be used to produce glass-ceramic materials include lithium zinc silicates, lithium aluminosilicates, lithium zinc aluminosilicates, lithium magnesium silicates, lithium magnesium aluminosilicates, magnesium aluminosilicates, calcium magnesium aluminosilicates, magnesium zinc silicates, calcium magnesium zinc silicates, zinc aluminosilicate systems calcium phosphates, calcium silicophosphates and barium silicate. While the transparency of the resulting glass-ceramic compositions was not specified, the use of a fiber-filled backing layer is likely to render these composites opaque.
   (iii) U.S. Pat. No. 5,496,640 (Bolton and Smith, 1996) describes fire- and impact-resistant transparent laminates comprising parallel sheets of glass-ceramic and polymer, with intended use for security or armor glass capable of withstanding high heat and direct flames. Materials listed in the patent include commercial plate glass, float or sheet glass compositions, annealed glass, tempered glass, chemically strengthened glass, PYREX® glass, borosilicate glasses, lithium containing glasses, PYROCERAM, lithium containing ceramics, nucleated ceramics and a variety of polymer materials.

In addition to the materials mentioned above, additional materials and methods have also been investigated for ballistic protection. U.S. Pat. No. 5,045,371 (Calkins, 1991) describes a glass composite armor having a soda-lime glass matrix with particles of a pre-formed ceramic material dispersed throughout the material. The ceramic material was not grown in situ as is the case with glass-ceramics but was added to a glass. U.S. Patent Application No. 2005/0119104 A1 (Alexander et al) describes an opaque, not transparent, armor based on anorthite [CaAl₂Si₂O₈] glass-ceramics.

While the materials and method described above have afforded ballistic protection, improvements in the area of transparent armor material systems are sorely needed. As the AMPTIAC Newsletter, Fall 2000, has stated: “Future warfighter environments will require lightweight, threat adjustable, multifunctional and affordable armor, which the current glass/polycarbonate technologies are not expected to met.” The present invention is specifically directed to an improvement in the structural design of armor, and in particular transparent armor, that provides for improved shock wave, stress and energy mitigation mechanisms when the armor is struck by a projectile.

### SUMMARY

The invention is directed to an armor laminate, transparent or non-transparent, comprising a plurality of layers, said laminate having at least one non-planar interface formed by and between at least two adjacent layers of the laminate; for example, one layer has a concave surface and the layer adjacent to it has a corresponding convex surface that mates to the concave surface. In transparent armor embodiments the laminate is a transparent laminate in which each transparent layer is individually selected from the group consisting of transparent glass, glass-ceramics, polymer and crystalline materials. In non-transparent armor laminates the individual layers are non-transparent layers. Examples, without limitation, of the non-transparent materials that can be used in the armor are non-transparent glass-ceramics, aluminum, titanium, steel, and metal alloys. In another embodiment of non-transparent laminates, the non-transparent laminate can have both transparent and non-transparent layers. The non-planar interface surfaces according to the invention can be of any non-planar shape. Examples of such shapes, without limitation, include concave/convex, zigzag or sinusoidal shapes. The layers of the laminates, whether transparent or non-transparent, are bonded together using an adhesive or interlayer material that effects a bond between the layers by the application of pressure and/or heat and/or, in the case of transparent layers, electromagnetic radiation. In the case of transparent material the adhesive or interlayer material has a refractive index matched or as closely matched as possible to the refractive index of the transparent layers so that distortion or other detriments to vision do not occur or is minimized after the layers have been laminated together.

In one embodiment of the invention the laminate is a transparent laminate having a plurality of layers, the first layer being a glass-ceramic layer and the remainder of the plurality of layers being a transparent material selected from the group consisting of glass-ceramics, glass, crystalline materials and polymeric materials. The layers of the laminate can be bonded or joined together using a transparent adhesive and/or polymeric interface material or an appropriate frit material that is transparent after being heated to bond the laminate layers together.

In one embodiment of the invention the first layer or strike face is a harder layer than the subsequent layers and the sides of the first layer and the layer adjacent to the first layer are non-planar.

In another embodiment of the invention the first layer or strike face is a softer layer than the layer adjacent to it and the sides of the first layer and the layer adjacent to the first layer are non-planar.

### BRIEF DESCRIPTION OF THE DRAWINGS

FIG. 1A illustrates a typical planar transparent armor laminate in which all the laminated faces are planar.

FIG. 1B is an X-t (space vs. time) diagram illustrating the shock wave reflection and transmission mechanism in a planar transparent armor lamination design upon plate-to-plate impact of the laminate of FIG. 1A.

FIG. 2A illustrates a non-planar interface design according to the invention.

FIG. 2B is an X-t diagram illustrating the shock wave reflection and transmission mechanism in a typical 2D (2 dimensional) non-planar interface design according to the invention.

FIG. 3A illustrates the FEA results showing the migration of the thermal mismatched stress field in a planar transparent armor design.

FIG. 3B illustrates the FEA results showing the migration of the thermal mismatched stress field in a non-planar transparent armor design.

FIGS. 4A-4C illustrate several single layer non-planar transparent armor interface designs according to the invention.

FIGS. 5A-5E illustrate several two-layer non-planar transparent armor interface designs according to the invention.

FIGS. 6A-6E illustrate several transparent armor interface designs according to the invention that have a plurality of non-planar layers.

FIG. 7 illustrates a typical non-planar interface design according to the invention in 2D form (left) and 3D (three dimensional) form (right).

FIG. 8 illustrates a non-planar design in which a hard layer (H) is embedded behind a soft layer (s), deflecting the projectile and changing the penetration angle of the projectile.

FIG. 9 illustrates a non-planar design according to invention in which the laminate has a layer 100 having a non-planar surface and a planar surface laminated between a layer 20* having a complimentary non-planar surface and a layer 30* having a planar surface.

### DETAILED DESCRIPTION

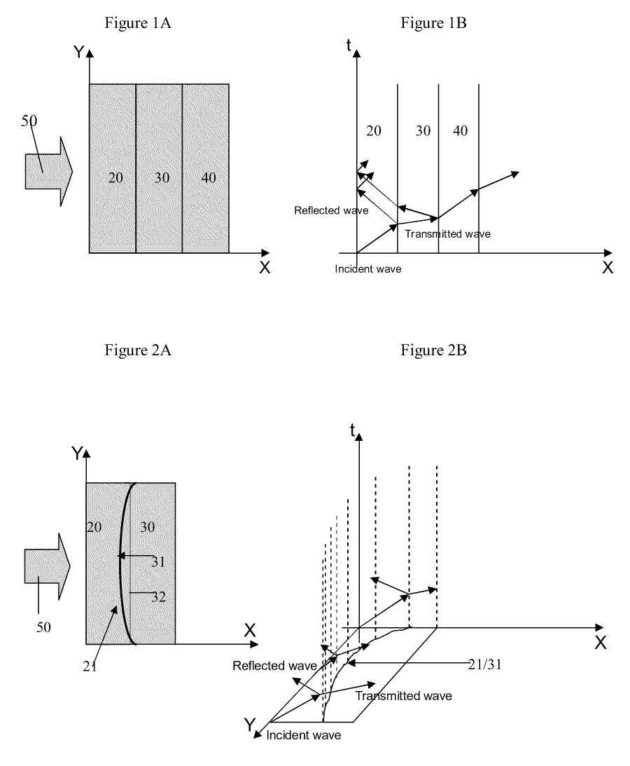

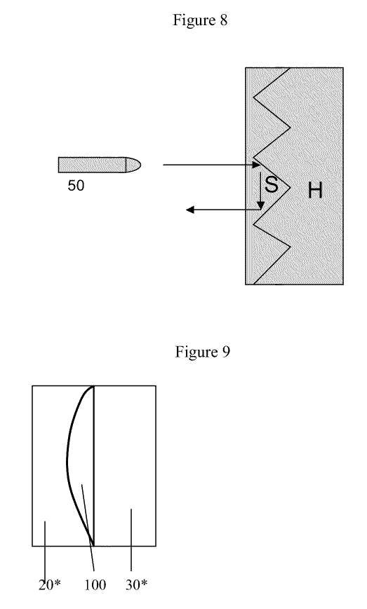

In all the Figures described herein the layers 20, 30, 40, 60, 70 and 80 represent transparent armor materials that are used to form the laminate. Numeral 50 is used to indicate an incoming projectile. Examples, without limitation, of the materials use to form the laminates include glass, glass-ceramics, crystalline and polymeric materials as have been described in the Background of the Invention. The layers 20, 30, 40, 60, 70 and 80 are laminated (bonded) together using an adhesive or an interlayer material (refractive index matched (or as closely index matched as possible) to the laminate layers to avoid and/or minimize distortion or the transmission of light), which interface layer(s) is/are not illustrated in the Figures. As used herein the term “a plurality of layers” means two or more layers. In the Figures planar surfaces are represented straight lines (see FIG. 1A) and non-planar surfaces are shaped, for example, a curve or arc (see FIG. 2A), zigzag or saw-tooth (see FIG. 8), or wave-like (see FIG. 4C). The surface furthest from the strike face is preferably planar.

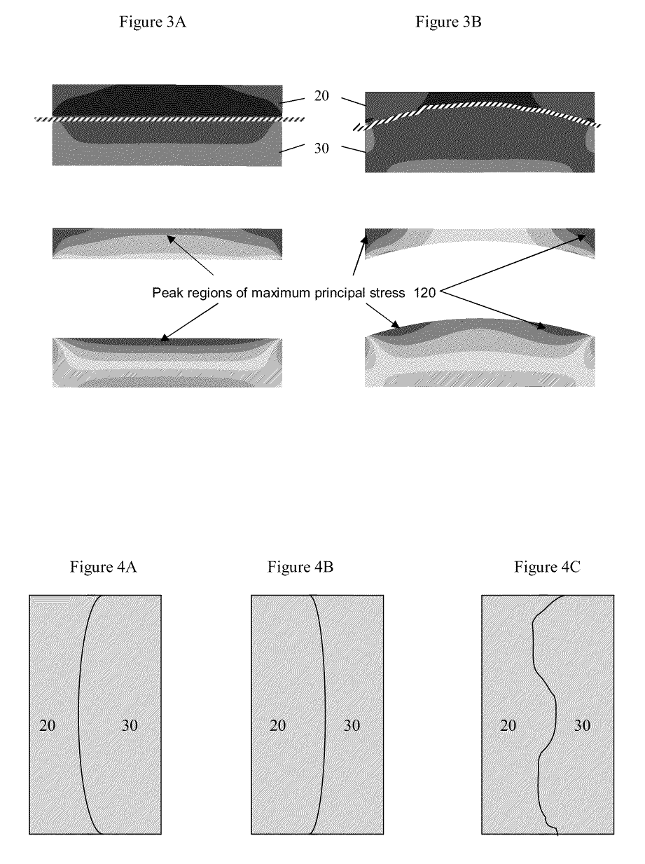

The present invention proposes an improvement to the multilayer structural design of a transparent armor. The designs and methods disclosed herein lead to an improved shock wave, stress and energy mitigation mechanism that has the potential to increase ballistic performance by modifying the shock wave propagation pattern and subsequent damage pattern. In particular, a non-planar interface design concept is used to modify the shock wave and failure wave pattern through geometry scattering and material sound impedance mismatch induced scattering. At the same time, the non-planar interface can modify the residual stress field to keep brittle layers under compression and change the weakest locations to specified locations (see FIGS. 3A and 3B). The non-planar interfaces can be achieved by laminating glass, ceramic, glass-ceramic, or plastic sheets having non-uniform (or non-planar) surface features, as shown by the examples in FIGS. 4 through 8.

The non-planar interface designs as described in the present invention offer the following advantages:
Modification of the shock wave profile
Mitigate the stress distribution
Mitigate the energy dissipation pattern
Enhance the penetration resistance and shock resistance of the armor
Fewer layers are required to defeat the projection which leads to weight savings
Better transparency because fewer layers are needed to met the ballistic threat

The biggest concern in transparent armor design is that transparent armor materials such as glasses and glass-ceramics are generally brittle. The extensive damages to the transparent material induced in the first shot will degrade the material to such an extent that it will not be able to protect against the following shots. Consequently, a tiling technique has been used to increase the multi-hit capability by constraining the damage zone to a small area. The damage usually involves extensive pulverizing, powdering and cracking from the center of impact to the outside. These damages are generated mainly due to a high amplitude shock wave interaction and stress relieving processes.

In the present invention, the novel method is disclosed that enables one to directly change the shock wave profile and stress field to modify the subsequent damage pattern by using armor laminates that have non-planar surfaces. The non-planar surfaces have complimentary shapes so that they can be joined together, typically using an interlayer material such as a polymer sheet or an adhesive. For example, a concave surface is laminated to a convex surface. In the non-planar configuration the distribution of the impact energy will be distributed into preferred areas. For instance, extensive but shallower damages may be designed to increase the penetration resistance if stopping the bullet is the biggest concern. In another instance, higher sound impedance material could be designed in a way to defeat the projectile in the earlier stages of penetration by throwing the incident shock wave back onto the projectile this causing the projectile to break up or deform.

FIG. 1A is an X-t (space vs. time) diagram that illustrates conventional planar transparent armor designs and FIG. 1B illustrates the shock wave reflection and transmission mechanism in a planar transparent armor lamination design upon a plate-to-plate impact. The armor in FIG. 1A is an exemplary armor laminate, in this case a 3-layer laminate, having a first layer or strike face 20, a second layer 30 and a third layer 40, the layers being having an interlayer/bonding-agent (not illustrated or numbered) between them. The interlayer is typically an organic material such as an adhesive or polymer sheet which is used to bond the layers to one another, although other materials such as frit materials (which are transparent after bonding is carried out) can be used to bond the layers. The arrow 50 in FIG. 1A represents the incoming projectile. FIG. 1B illustrates the transmission of forces (waves) as a result on impact of projectile 50 on the armor laminate. In FIG. 1B one can see that the reflected wave will interact with the incident wave starting at the interface, for example, at the boundary between materials 20 and 30 (vertical line from the X axis between 20 and 30). When the compressive stress wave (which is caused by the impact of an incoming projectile) propagates from the higher sound impedance layer to the lower sound impedance layer, the amplitude of a transmitted wave will be lower than the incident wave. At the same time, a reflected wave will have a different sign in comparison with the compressive incident wave which leads to a tensile wave. The interaction between the incident wave (compression) and reflected wave (tension) will potentially induce certain failure if the resulting tensile wave amplitude is larger than the tensile strength of the material. This is called spalling. The spalling process usually starts from local voids or micro-cracks. It then coalesces, growing into big cracks. If the shock wave induced micro-cracks are close together, they will have a greater chance to coalesce.

FIG. 2A is an X-t diagram illustrating a 2-layer non-planar armor laminate according to the invention which has a strike face 20 with a concave surface 21 and a second layer 30 which has a convex surface 31 matching concave surface 21. The vertical line 32 is present in FIG. 2A is present only to illustrate the difference between the planar interfaced laminate of FIG. 1A and the non-planar laminate of the invention. In other embodiments as illustrated by FIG. 9, a layer 100 having a non-planar surface and a planar surface can be laminated between a layer 20* having a complimentary non-planar surface and a layer 30* having a planar surface.

FIG. 2B illustrates the shock wave reflection and transmission mechanism in a typical non-planar armor laminate of the invention. [The same mechanism holds for laminates having more than two layers]. The changed shape of the interface, illustrated by the arc 21/31 in the xy-plane of the figure (the concave 21/convex 31 interface), will change the way the shock wave is reflected and transmitted. (The dashed vertical lines (not numbered) are used to three-dimensionally illustrate the non-planar surface as is rises from the xy-plane). This will lead to a scatter of the incident shock wave in the armor system. The interaction between incident wave and reflected wave induced spalling damages will happen over a larger area, destroying much of the material through wave interaction. Furthermore, the wave interaction induced micro-cracks will have less chance to coalesce and grow. Consequently, the impact energy of projectile 50 will be distributed through a larger volume of the material in the non-planar laminate system of the invention. The resulted larger volume of fractured pieces will further spread out the impact stress and lead to even larger volume of target materials to involve in defeating the projectile.

FIGS. 3A and 3B illustrate the stress mitigation mechanism by showing the thermal mismatched stress field changes between the planar interface design (FIG. 3A) and a non-planar interface design (FIG. 3B) from FEA (Finite Element Analysis), respectively. FEA is a computer simulation technique used in engineering analysis that can be for the determination of effects such as deformations, strains and stresses which are caused by applied loads such pressure due to an incoming projectile. Software, for example, NEiNastran™ (Noran Engineering, Westminster Calif.) and Abaqus™ (SIMULIA™, Warwick R.I.), for FEA analysis is commercially available.

The FEA mismatch shown in FIGS. 3A and 3B was obtained using two glass materials, Corning 1737 and 723 CWF (numerals 20 and 30, respectively, in the Figures) which are CTE mismatched. [The same type of analysis can be done using any two glass, glass-ceramic, ceramic, etc. materials that have different CTE values]. The top illustration in FIGS. 3A and 3B shown the two glasses bonded together. The dashed line in each Figure is used only to illustrate the interface (planar in 3A and non-planar in 3B) and does not represent another laminate layer or the interlayer material. The lower two illustrations are a break-apart of the top illustration in order to better show and illustrate the peak regions of maximum principal stress 120 as indicated by the text and the arrows. The FIGS. 3A and 3B show that the regions of higher maximum principal stress (shown by the arrows) changes from almost the entire top layer 20 (strike face) in the planar case to only the left and right sides of the top layer in the non-planar case. This illustrates how a non-planar interface design can mitigate the CTE mismatch induced residual stress from manufacturing process to the sides of the sample which is the less important region. In other words, the residual stress can be redirected to an area that is not as important for maintaining structural integrity after the surface is hit by a projectile. This change will help induce more shallow damage with less penetration upon piercing projectiles. FIGS. 3A and 3B are used only to demonstrate the stress mitigation mechanism. Arbitrary material properties were selected to generate the FEA results. Similar analyses can be carried out in a more detailed study with a specific non-planar interface design and with any of the materials suitable for the armor applications. In the case of transparent armor laminates these materials are transparent glass, glass-ceramic, crystalline and polymeric materials. For non-transparent applications the materials can be any of the non-transparent materials described herein or a combination of transparent and non-transparent materials as also described herein.

FIGS. 4A-4C illustrate several single interfacial layer non-planar interface designs. Materials A and B can be glasses, ceramics, glass-ceramics and polymers. The exact sequence of interfacial design can be optimized further to achieve the best performance.

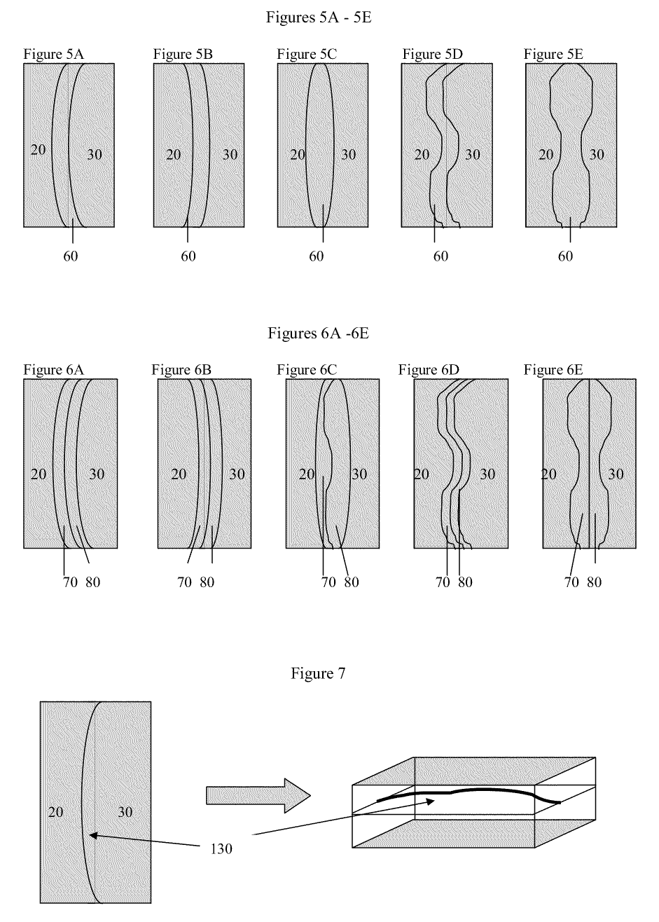

FIGS. 5A-5E illustrate several double interfacial layer non-planar interface designs. Materials A and B can be glasses, ceramics, glass ceramics and polymers. The exact sequence of interfacial design can be optimized further to achieve the best performance.

FIGS. 6A-6E illustrate several designs that have multiple interfacial layer non-planar interfaces. Materials A and B can be glasses, ceramics, glass ceramics and polymers. The exact sequence of interfacial design can be optimized further to achieve the best performance. For example, FIG. 6A illustrates a laminate having three concave and three convex interfaces and FIG. 6D illustrates a laminate having three wave-like interfaces. FIG. 6E illustrated a laminate having a “dumbbell” shape, the dumbbells being formed by two half-dumbbell layers 70 and 80 bonded to one another at a planar interface (as illustrated in FIG. 6E). FIG. 5E illustrates a unitary, one-piece dumbbell 60 (without the planar interface as illustrated in FIG. 6E) bonded to layers 20 and 30.

FIGS. 4A-4C, 5A-5E and 6A-6E illustrate that the design of the non-planar interface can have different shapes, and further that more than one different non-planar shape can be incorporated within a single design (see FIG. 6C in which the laminate contains more than one non-planar interface between adjacent layers, the non-planar interfaces being between different pairs of adjacent layers such as the non-planar interface between elements 20 and 70, the non-planar interface between elements 70 and 80, and the non-planar interface between elements 80 and 30). As one can see from FIG. 6C, the interfaces can be different. It should be clearly understood that the invention is not limited to only those designs shown or the use of any particular non-planar interfacial design. The principles described herein apply to all non-planar interfacial designs. Thus, within a single laminate of a plurality of layers one can have, for example, one can have a first concave/convex non-planar interface between a first layer (the strike face) and a second layer, a saw-tooth or zigzag interface between the second layer and a third layer, and a wave (for example, a sinusoidal wave) shape between the third layer and a fourth layer. The materials used for the layers can be transparent glass, glass-ceramic, or polymeric materials. In preferred embodiments the last layer (the one furthest from the strike face) is preferably a transparent polymeric material such as a polycarbonate material. In wave, saw-tooth and zigzag designs the “peak-to-peak” distance can be constant or variable.

FIG. 7 shows a typical non-planar interface design in both 2D (left side) and 3D (right side) illustrations. The arrow 130 is for correlation of the non-planar interface (concave/convex) in the two Figures. The broad line in the right hand 3D illustration represents a portion of the concave/convex surface as shown in the 2D illustration. The previous 2D versions as shown in the other Figures can also be expanded into 3D versions if desired.

In typical transparent armor the first layer or strike face can be a harder layer than the subsequent layer(s). However, all the layers can be made of the same material. However, as disclosed below, an armor laminate configuration in which the strike face layer is softer than at least the subsequent layer of the laminate also presents advantages. The non-planar interface design on the invention can also serve the purpose of deflecting the projectile upon impact to reduce the input impact energy. FIG. 8 demonstrates a design in which the hard layer was embedded behind the soft layer, deflecting the projectile and changing the penetration angle of the projectile to reduce the threat level. In reference to FIG. 8, “hard” and “soft” have a different meaning than that of the previously mentioned higher and lower sound impedance when we talk about stress wave propagation. In FIG. 8 hardness and softness are used as relative terms and are based on the Knoop Hardness (“KH”) value of the material. A material with a KH of 700 would be deemed harder than one with a KH of 400. However, the sound impedance may or may not correlate with the KH value. That is, a 700 KH material could have a lower sound impedance than a 400 KH material, or 700 KH material could have a higher sound impedance than a 400 KH material. The sound (or acoustic) impedance (“SI”) of a material is the product of density (“ρ”) and sound speed or velocity of sound through the material (“V”) and is represented by the equation

SI=ρV

Sound impedance can be calculated for any material as long as the density and sound speed of the material are known. Metals generally have a higher sound impedance than ceramic materials, but ceramic and crystalline materials generally have a higher hardness than metals. Table 1 illustrates that high (or low) Knoop Hardness does not necessarily correspond to high (Or low) Sound (Acoustic) Impedance

TABLE 1

| | | Sound (Acoustic) |
|---|---|---|
| | Knoop Hardness | Impedance |
| Material | (kgf/mm²) | (Ray1 × 10⁶) |
| Lead | 7 | 24 |
| Aluminum | ~20-40 | 17 |
| Copper | 87 | 42 |
| Steel | 227 | 46 |
| Iron (grey) | 270-300 | 46 |
| Glass-ceramic (Macor ™) | 250 | 14 |
| Polycarbonate | ~300-400 | 2.7 |
| | | (plastics generally |
| | | 2.0-3.5) |
| Fused Silica | 522 | 12.5 |
| Glass (Pyrex ™) | 550 | 13 |
| Quartz (synthetic) | 815 | 15 |
| Silicon Nitride | 1737 | 36 |

1 Ray1 = 1 Newton-second per cubic meter or (equivalently) 1 Pascal-second per meter.

The non-planar interfacial design laminate design described herein can also be used to make non-transparent armor laminates made of one or a plurality of material layers that can be the same or different. For example, the materials can be non-transparent glass-ceramic, aluminum, titanium, steel, metal alloys, silicon carbide, titanium diboride, tungsten carbide, aluminum oxide, boron carbide, and carbon fiber or other fiber (metallic or non-metallic) reinforced polymer, ceramic or glass materials among others. In another embodiment the non-transparent armor can be made of a combination of transparent and non-transparent materials, the non-transparent material(s) imparting non-transparency to the entire laminate.

An example of a transparent armor laminate according to invention having a hard first layer is a laminate in which the first layer has a Knoop Hardness greater than the Knoop Hardness of the layer adjacent to the first layer, the last layer is a spall catcher layer (typically a polymer layer) and one or a plurality of layers selected from the group consisting of glass, glass-ceramic, polymer and crystalline materials between the first layer and the spall catcher layer; and at least the first layer and the layer adjacent to the first layer having complimentary non-planar surfaces.

An further example of a transparent armor laminate according to invention having a hard first layer is a laminate in which the first layer is a glass-ceramic layer, the last layer is a spall catcher layer (typically a polymer layer) and one or a plurality of layers selected from the group consisting of glass, glass-ceramic, polymer and crystalline materials between the first layer and the spall catcher layer; and at least the first layer and the layer adjacent to the first layer having complimentary non-planar surfaces, and the first layer has a sound impedance greater than the sound impedance of the adjacent layer.

An example of a transparent armor laminate according to invention having a soft first layer is a laminate in which the first layer has a Knoop Hardness less than the Knoop hardness of the layer adjacent to the first layer, the last layer is a spall catcher layer (typically a polymer layer) and one or a plurality of layers selected from the group consisting of glass, glass-ceramic, polymer and crystalline materials between the first layer and the spall catcher layer; and at least the first layer and the layer adjacent to the first layer having complimentary non-planar surfaces. Examples, without limitation, include laminates in which the first layer and the layer adjacent to the first layer are, respectively, polymer/glass, polymer/glass-ceramic), glass/glass-ceramic, glass/crystalline material, and polymer/crystalline material, provided that the first layer has a Knoop Hardness less than the Knoop hardness of the layer adjacent to the first layer.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

I claim:

1. An armor laminate comprising a plurality of layers, said laminate having at least one non-planar interface between at least two laminate layers and an interlayer material between said laminate layers.

2. An armor laminate according to claim 1, wherein said laminate layers are transparent layers and each transparent layer is individually selected from the group consisting of transparent glass, glass-ceramic, polymer and crystalline materials.

3. An armor laminate according to claim 1, wherein the at least one non-planar interface surface between two laminate layers has a shape selected from the group consisting of concave/convex, zigzag, saw-tooth, wave-like, dumbbell and sinusoidal shapes.

4. The armor laminate according to claim 1, wherein the laminate contains a plurality of transparent layers and said laminate further contains a plurality of non-planar interfaces between different pairs of adjacent layers

5. The armor laminate according to claim 1, wherein said laminate is a transparent laminate in which:
the first layer has a sound impedance greater than the sound impedance of the layer adjacent to it,
the last layer is a spall catcher layer, and
one or a plurality of layers selected from the group consisting of glass, glass-ceramic, polymer and crystalline materials is between the first layer and the spall catcher layer; and
at least the first layer and the layer adjacent to the first layer have complimentary non-planar surfaces.

6. The armor laminate according to claim 5, wherein the first layer is a glass-ceramic layer.

7. The armor laminate according to claim 1, wherein said laminate is a transparent laminate in which:
the first layer is has a Knoop Hardness less than the Knoop Hardness of the layer adjacent to it,
the last layer is a spall catcher layer, and
one or a plurality of layers selected from the group consisting of glass, glass-ceramic and crystalline materials is between the first layer and the spall catcher layer; and
at least the first layer and the layer adjacent to the first layer have complimentary non-planar surfaces.

8. An armor laminate comprising a plurality of layers, said laminate having a planar strike face, a planar final face, and a plurality of non-planar interfaces between different the laminate layers, and an interlayer material between said laminate layers;
wherein the first layer is has a Knoop Hardness greater than the Knoop Hardness of the layer adjacent to it and has a planar strike facet,
the last layer is a polymeric spall catcher layer having a planar final face, and
the plurality of layers between the first layer and the spall catcher layer is selected from the group consisting of glass, glass-ceramic and crystalline materials; and
at least the first layer and the layer adjacent to the first layer have complimentary non-planar surfaces.

9. An armor laminate comprising a plurality of layers, said laminate having at least one non-planar interface between at least two laminate layers and an interlayer material between said laminate layers
wherein said laminate layers are non-transparent layers and each non-transparent layer is individually selected from the group consisting non-transparent glass-ceramic, polymer, aluminum, titanium, steel, and metal alloys.

10. An armor laminate according to claim 9, wherein the at least one non-planar interface surface between two laminate layers has a shape selected from the group consisting of concave/convex, zigzag, saw-tooth, wave-like, dumbbell and sinusoidal shapes.
